(19) United States
(12) Patent Application Publication
(10) Pub. No.: US 2018/0017393 A1
(43) Pub. Date: Jan. 18, 2018

(54) Handicap assist apparatus

(71) Applicant: Robert Willson, Tucson, AZ (US)

(72) Inventor: Robert Willson, Tucson, AZ (US)

(21) Appl. No.: 14/999,886

(22) Filed: Jul. 14, 2016

(51) Int. Cl. G01C 21/20; G09B 1/00; A61H 3/06

(52) U.S. Cl. CPC G01C 21/20; A61H 3/061; A61H 3/068; G09B 1/00; A61H 3/06; A61H 2201/169; A61H 2201/5048; A61H 2201/165

(57) ABSTRACT

The invention is an assist apparatus ideally used by the visually impaired. Within a housing unit is an identifier mechanism such as a Radio Frequency Identification (RFID). The RFID generates a unique radio signal which is received by and triangulated by a group/grid of receivers within the building. The triangulation allows a computer to identify the position/location of the user for assistance or to generate a set of instructions for the visually impaired user to move to a specific location. The instructions are communicated to the user, ideally through a tactile interface, allowing the visually impaired to navigate in a strange environment.

### BACKGROUND OF THE INVENTION

This invention relates generally to assist apparatus for the disabled and more specifically to apparatus used in unfamiliar locations by the visually impaired.

Many visually impaired and other disabled individuals travel by air or other type of public transportation. For this discussion, airports will be used as illustrative of the invention's application; although those of ordinary skill in the art readily recognize a variety of other unfamiliar surroundings where the invention is applicable, such as, but not limited to: bus terminals, public buildings, museums, rail terminals, and libraries.

At the present time, when a blind or visually impaired person arrives at the airport without an escort there isn't any system to assist the individual to travel from the curb to the airline check-in counter. This creates an extensive barrier for the visually impaired person.

While airlines have attempted to provide human assistance after the blind/visually impaired individual has been identified, all too often the blind person is difficult to located and identify in the mass of people at the airport. In addition, the blind/visually impaired person is unable to read an airport ID badge and therefore is placed at risk when following an unknown person.

It is clear from the foregoing that there is a significant need for apparatus which will provide arrival notification, location, identification, and status to airport representatives to enhance assistance, access, security and mobility for disable individuals.

### SUMMARY OF THE INVENTION

The invention is an assist apparatus ideally used by the visually impaired. Within this context, the “visually impaired” include those that are totally blind as well as partial blindness. Note that the invention is also useful for anyone who is encountering an unknown domain and needs to traverse it.

In the invention, an identifier mechanism such as a Radio Frequency Identification (RFID) is contained within a housing unit. RFIDs are generally either “active” or “passive” in nature.

Those of ordinary skill in the art readily recognize a variety of RFID chips which may be used in this context, including, but not limited to those described in U.S. Pat. No. 9,336,476, entitled “Method of Making RFIOD Devices on Fabrics by Stitching Metal Wires” issued to Liu et al. on May 10, 2016; and, U.S. Pat. No. 9,336,423, entitled “Analyte Meter Including an RFID Reader” issued to Goodnow et al. on May 10, 2016; both of which are incorporated hereinto by reference.

In the ideal embodiment of the invention, the user is able to selectively activate the RFID when they are ready for instructions or for assistance. These selective activation mechanisms are well known to those of ordinary skill in the art including, but not limited that described in U.S. Pat. No. 9,342,777, entitled “Programmatic Control of RFID Tags” issued to Piersol et al. on May 17, 2016, and incorporated hereinto by reference.

The RFID generates a unique radio signal which is received by and triangulated by a group or grid of sensors/receivers. In the example of an airport, these receivers are positioned ideally in a grid type of arrangement so that “blank” locations are minimized or eliminated.

Receivers for RFID radio frequencies are well known to those of ordinary skill in the art and include, but are not limited to those describe in U.S. Pat. No. 9,336,639, entitled “Radio Frequency Identification Tagging” issued to Fogg on May 10, 2016; and, U.S. Pat. No. 9,338,606, entitled “Distributed Method and System for Determining the Position of a Mobile Device Using long-Range Signals and Calibrating the Position using Short-Range Signals” issued to Moshfeghi on May 10, 2016; both of which are incorporated hereinto by reference.

The triangulation is performed by a computer to locate the position of the activated RFID within the grid. Computer triangulation and the use of computers in conjunction with RFIDs is well known to those of ordinary skill in the art and include the arrangement described in U.S. Pat. No. 9,339,697, entitled “RFID Golf Ball Target System and Method” issued to Luciano Jr. et al. on May 17, 2016, incorporated hereinto by reference.

The user provides the computer with a “request” such as “American Airlines Counter” or “restroom”. Those of ordinary skill in the art readily recognize a variety of systems to provide these requests and to receive feedback including, but not limited to, that described in U.S. Pat. No. 9,342,716, entitled “Software-Defined Multi-Mode Read Devices” issued to Raptis et al. on May 17, 2016, incorporated herein by reference.

In the guidance embodiment of the invention, after pressing a button on the cane to activate the RFID transponder, the transceiver (Bluetooth or WiFi) automatically establishes communication with the facility using a pre-programmed protocol. Within a few seconds, the user hears a computer generated menu via the speaker or headset asking the user to select a destination such as American Airlines Ticket Counter or a restroom, and respond by pressing a number key on the keypad or by switching the passive RFID off/on. Those of ordinary skill in the art readily recognize a variety of systems to provide these requests and to receive feedback including, but not limited to, that described in U.S. Pat. No. 9,342,716, entitled “Software-Defined Multi-Mode Read Devices” issued to Raptis et al. on May 17, 2016, incorporated herein by reference.

Using the user's location, as determined by the facility's RFID grid and the active RFID transponder in the cane, the compass in the cane to determine direction the user is facing, and the “map” of the facility stored as a data base, the computer plots a course from the user's location to the desired destination avoiding any obstacles. The instructions for this course are converted into commands to direct the user. The directions to the user are either aural or tactile.

The possible choices of aural commands are simple voice commands generated by the computer sent via the Bluetooth or WiFi transceiver and heard via the speaker or headphones. Another choice is a series of tones that differentiate between forward, right, left and stop that also change amplitude with the amount of correction needed. Those of ordinary skill in the art recognize a variety of techniques which can be used in this context, including, but not limited to those described in U.S. Pat. No. 8,325,752, entitled “Technique for Sharing Transmit and Receive Port of a CMOS based Transceiver” issued to Rajendran et al. on Dec. 4, 2012; U.S. Pat. No. 7,198,518, entitle “Satellite Signal Receivers used with Blue Tooth Transmission and Electronic Maps” issued to Liou on Apr. 3, 2007; and, U.S. Pat. No. 8,319,613, entitled “Smart Cap with Communication Function” issued to Lazar on Nov. 27, 2012; all of which are incorporated hereinto by reference.

In some embodiments, several small vibration devices are built into the cane and provide tactile commands such as forward, right, left and stop. Changes in amplitude may correspond to the amount of correction required. A variety of mechanisms are known to provide tactile communication of the instructions including, but not limited to, those described U.S. Pat. No. 9,185,4982, entitled “Systems and Methods for Acousto-Haptic Speakers” issued to Afshar and incorporated hereinto by reference.

In this context, the computer plots a course from the user's location to the desired destination. The instructions for this course are used in directing the user. In the preferred embodiment, the original stored “map” for the computer to use is created by passing an RFID around the circumference of the walls and doorways within the structure. This technique assures that the map is accurate and self-correcting for any distortions/echoes/and other abnormalities which occur naturally within a building.

The triangulation allows the computer to identify the location of the user for human assistance or to generate a set of instructions for the visually impaired user to move to a specific location (i.e. the check in desk, a bathroom, or security check point”). In this context, the instructions are also useful for an unimpaired person entering an unknown airport so that the gate can be located.

The instructions are communicated to the user, ideally through a tactile interface, allowing the visually impaired to navigate in a strange environment. A variety of mechanisms are known to provide tactile communication of the instructions including, but not limited to, those described U.S. Pat. No. 9,185,4982, entitled “Systems and Methods for Acousto-Haptic Speakers” issued to Afshar and incorporated hereinto by reference.

Within the present invention, the preferred embodiment is housed within a cane. Another embodiment is housed and carried on a wrist of the user. In this embodiment, the tactile contacts are within the band of the wrist mechanism and often includes a watch.

In this context, the wrist band embodiment, those of ordinary skill in the art readily recognize a variety of arrangements for inclusion of an RFID in the watch or wrist band, including, but not limited to that described in U.S. Pat. No. 9,336,477, entitled “RFID Wrist Band” issued to Nitta on May 10, 2016, and incorporated hereinto by reference.

While the preferred embodiment uses tactile communication, other embodiments use audio communicated ideally through ear plugs or the such. Those of ordinary skill in the art recognize a variety of techniques which can be used in this context, including, but not limited to those described in U.S. Pat. No. 8,325,752, entitled “Technique for Sharing Transmit and Receive Port of a CMOS based Transceiver” issued to Rajendran et al. on Dec. 4, 2012; U.S. Pat. No. 7,198,518, entitle “Satellite Signal Receivers used with Blue Tooth Transmission and Electronic Maps” issued to Liou on Apr. 3, 2007; and, U.S. Pat. No. 8,319,613, entitled “Smart Cap with Communication Function” issued to Lazar on Nov. 27, 2012; all of which are incorporated hereinto by reference.

For the preferred embodiment, the System uses an active UHF Radio Frequency Identification Device (RFID) built into the white cane commonly carried by people who are visually impaired. Using multiple fixed RFID readers and antennas, computer and software (middleware) the system provides both fixed and handheld displays for assistance personnel at the airport for arrival notification, real-time location and status information on the arriving visually impaired individual. The RFID ideally provides additional information such as contact and medical alert information which is obtained from a data base.

When the cane is purchased/received by the visually impaired person, a registration form is completed, likely with assistance from a sighted family member or friend, and sent to an office assigned by the Federal Aviation Administration (FAA). This registration information contains the salient information of name, address, contact and medical alert information, but most importantly, a unique transponder number that the person retains.

In operation, when the blind person exits a cab at an airport without a family member, friend or helper, he/she activates the RFID by pressing a button on the cane or through voice activation and hears a subdued “beep, beep, beep” confirming his/her mechanism is activated. Note, someone who is both blind and deaf will feel a vibration. This integrated system at the airport immediately presents a visual and audio alert on an airport computer display screen and automatically sends a text message to an airport staff member who now knows that a visually impaired person is requesting assistance, where the person is located, his/her transponder number, name, and status (routine or emergency) is given to the care giver from the airport. In addition, if requested via the software, additional information may be obtained from a data base containing the information from the registration form.

Upon approaching the person requesting assistance, the airport staff member introduces himself/herself to the person and states the transponder number and the impaired user's name. The visually impaired person, who cannot read an ID badge, now knows with confidence that this person is someone cleared by the airport for access to the information and is here to assist.

In one embodiment, the apparatus is expanded to include any person with a disability and persons needing a wheelchair or other assistance due to an injury. For this embodiment, the transponder is configured in a small case similar to a car remote key.

This embodiment is especially applicable for an unaccompanied minor. Using this invention, they are easily monitored and located by airline and airport personnel. In this type of application, the mechanism is ideally worn as a pendant around the child's neck. This mechanism also allows the child to request immediate assistance if needed.

The location accuracy of this system is very good, and is only limited by the airport installation of multiple readers and antennas and the physical layout of the airport structure. The more readers and antennas installed and the more open the facility, the smaller the grid zones that are be created resulting in improved accuracy. However, note that with even a small amount of readers properly placed, zones the size of a small room can be created and location accuracies of a few meters can be achieved.

The invention, together with various embodiments will be more fully explained by the accompanying drawings and the following description thereof.

### DRAWINGS IN BRIEF

FIG. 1 is a schematic of the general operation of the preferred embodiment of the invention.

FIGS. 2A, 2B, and 2C illustrate different embodiments for the housing of the assist apparatus.

FIG. 3 illustrates an auditory embodiment of the invention.

### DRAWINGS IN DETAIL

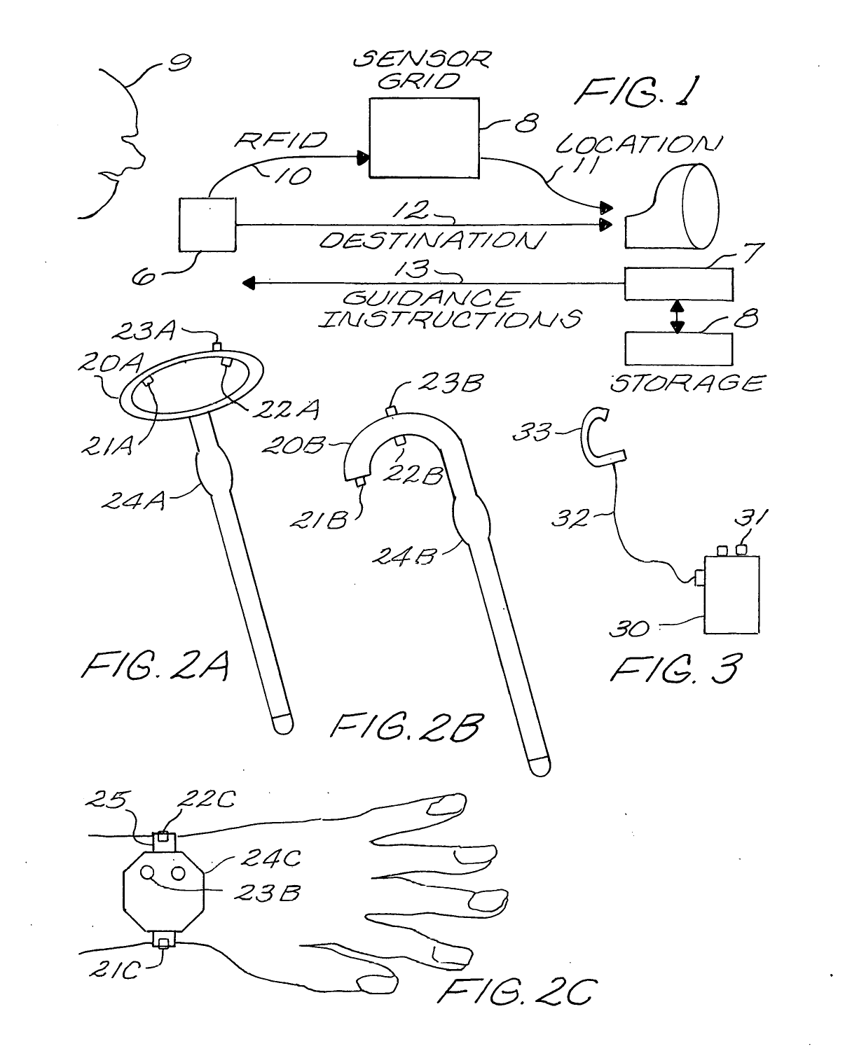

FIG. 1 is a schematic of the general operation of the preferred embodiment of the invention.

Sensor grid 8 is established in the building and is adapted to receive signals 10 from the RFID from unit 6 controlled by user 9. Using the unique qualities of the RFID, the individual user 9 is quickly identified and a variety of information is obtainable to assist in the process.

Sensor grid 8 provides a grouping of vectors which are directed to unit 6. These vectors, communicated 11 to computer 7 allow computer 7 to triangulate the position of unit 6.

User 9, via unit 6, communicates a desired destination 12 to computer 7. When the button on unit 6 is depressed and released by the user 9, the RFID transponder begins transmitting a signal 10 for routine assistance. In one embodiment of the invention, when the button on unit 6 is depressed and held for at least 3 seconds by the user 9, the RFID transponder begins transmitting a signal 10 for emergency assistance.

In another embodiment, when the button on unit 6 is depressed and released by the user 9, the RFID transponder begins transmitting a signal 10 requesting a computer generated menu. When the button on unit 6 is depressed and held for at least 3 seconds by the user 9, the RFID transponder begins transmitting a signal 10 for emergency assistance. Using the unique qualities of the RFID, the individual user 9 is quickly identified and communication between the Bluetooth or WiFi transceivers in unit 6 and the facility is established using a pre-programmed protocol.

Within a few seconds, the user 9 hears a computer generated menu via the speaker or headset with the unit 6 asking the user 9 to select a destination such as the American Airlines Ticket Counter or a restroom, and respond by pressing a number key on the keypad in unit.

Computer 7, using data from storage mechanism 8, contains an electronic map of the building and the desired location. Computer 7 communicates guidance instructions 13 to unit 6. These guidance instructions are communicated to impaired user 9. As user 9 navigates towards the destination, sensor grid 8 updates the vectors, computer 7 updates the new location of user 9, and further guidance instructions 13 are sent to unit 6/user 9.

Through this feed-back arrangement, user 9 is directed to the destination selected by user 9. This provides a very high level of freedom for the blind or partially blind individual.

In another embodiment, the user 9 needs assistance from a human. In this embodiment, the “need help” button is activated and computer 7 dispatches personnel to the assist user 7. The personnel, via computer 7's database 8, is provided identifying information of user 7 so that the airport personnel can verbally identify user 7, thereby providing a high level of security and confidence that it is truly airport personnel approaching the blind user 7.

In the preferred embodiment, the guidance instructions are communicated through tactile interface; in an alternative embodiment, unit 6 communicates audibly and receives instructions from user 9 audibly. Further, in some embodiments, the RFID is activated by voice command from user 9

FIGS. 2A, 2B, and 2C illustrate different embodiments for the housing of the assist apparatus.

As shown in FIG. 2A, the walking assist apparatus (which is the housing for the mechanism) of this embodiment utilizes an oval handle 20A on which is positioned the on/off switch 23A. Tactile communication with the user is via vibrating probes 21A and 22A which direct the user to the right or left respectively.

The RFID and other control mechanisms is contained within unit 24A.

The cane embodiment of figure utilizes a traditional shaped handle 20B. Switch 23B provides for the on/off of the RFID (not shown) housed within unit 24B. Tactile communication with the user is via vibrating probes 21B and 22B which direct the user to the right or left respectively.

The embodiment of FIG. 2C is a wrist mounted mechanism which in some embodiments of the invention include a “braile-type” of watch. Housing unit 24C encloses the RFID and any controllers required. The RFID is activated via switch 23B. Vibrating probes 21C and 22C (contained within band 25) direct the user to the right or left respectively.

FIG. 3 illustrates an auditory embodiment of the invention. Receiver housing 30 contains the RFID (not shown) which is activated via switch 31. Auditory signals are received and communicated via wire 32 to ear speaker 33 to direct the user to the desired destination.

While this embodiment uses wire 32, other embodiments use a wireless arrangement.

It is clear the invention provides a mechanism which provides a significant improvement in the level of freedom for handicapped individuals.

What is claimed is:

1. An apparatus to assist handicapped individuals navigate in unfamiliar surroundings comprising:
a) an identifier mechanism generating a radio signal containing a unique identifier in the radio signal;
b) a communication mechanism receiving guidance instructions from a remote computer, said communication mechanism communicating said guidance instructions to a user of the apparatus to assist handicapped individuals.

2. The apparatus to assist handicapped individuals navigate in unfamiliar surroundings according to claim 1,
a. further including a housing containing the apparatus to assist handicapped individuals navigate; and,
b. wherein the communication mechanism communicates the guidance instructions to the user of the apparatus to assist handicapped individuals by tactile contact with the user of the apparatus to assist handicapped individuals.

3. The apparatus to assist handicapped individuals navigate in unfamiliar surroundings according to claim 2,
a. wherein the housing is a walking assist mechanism; and,
b. wherein the tactile contact communicates a direction for the user to proceed.

4. The apparatus to assist handicapped individuals navigate in unfamiliar surroundings according to claim 3, wherein the walking assist mechanism is a walking cane.

5. The apparatus to assist handicapped individuals navigate in unfamiliar surroundings according to claim 1, wherein the communication mechanism communicates with the user of the apparatus to assist handicapped individuals in an audible fashion.

6. The apparatus to assist handicapped individuals navigate in unfamiliar surroundings according to claim 1, wherein the housing is worn by the user.

7. The apparatus to assist handicapped individuals navigate in unfamiliar surroundings according to claim 6, wherein the housing is worn on a user's wrist and wherein tactile contacts communicating the guidance instructions are positioned in a band securing the housing to the user's wrist.

8. The apparatus to assist handicapped individuals navigate in unfamiliar surroundings according to claim 7, wherein the identifier mechanism is voice is selectively activated by a user of the apparatus.

9. A system adapted to assist handicapped individuals navigate in unfamiliar surroundings comprising:
a. a sensor grid, each sensor in said grid able to receive a selected radio signal and generate therefrom a directional vector to the source of the radio signal;
b. a computer responsive to the directional vectors to locate a position of the source of the selected radio signal and generating guidance instructions to a selected location therefrom; and,
c. a handicap assist apparatus for use by a handicapped individual, said apparatus having:
1. an identifier mechanism generating a unique radio signal adapted to be received by the sensor grid, and,
2. a communication mechanism receiving the guidance instructions from a remote computer, said communication mechanism communicating said guidance instructions to a user of the handicap assist apparatus.

10. The system according to claim 9, wherein the communication mechanism communicates the guidance instructions to the user of the apparatus to assist handicapped individuals by tactile contact with the user of the apparatus to assist handicapped individuals.

11. The system according to claim 10, wherein the handicap assist apparatus is a walking cane.

12. The system according to claim 9, wherein apparatus is securable to a wrist of the user.

13. The system according to claim 9, wherein the identifier mechanism is selectively activatable by a user of the apparatus.

14. The system according to claim 13, wherein the identifier mechanism is voice activatable by a user of the apparatus.

15. An assist apparatus comprising:
a) a housing unit adapted to be carried by an individual;
b) an identifier mechanism contained within the housing unit and selectively generating a radio signal containing a unique identifier therein;
c) a communication mechanism contained within the housing unit, said communication mechanism receiving guidance instructions from a remote computer; and,
d) a user interface communicating the guidance instructions to a user of the assist apparatus.

16. The assist apparatus according to claim 15,
a. wherein the housing unit is a walking assist mechanism; and,
b. wherein the user interface communicates the guidance instructions via selective tactile contact with the user of the assist apparatus.

17. The assist apparatus s according to claim 15, wherein the housing unit is a walking cane.

18. The assist apparatus according to claim 16, wherein the housing unit is worn on a user's wrist.

19. The assist apparatus according to claim 16, wherein the identifier mechanism is selectively activatable by a user of the assist apparatus.
